(19) United States
(12) Patent Application Publication
(10) Pub. No.: US 2025/0271107 A1
(43) Pub. Date: Aug. 28, 2025

(54) BAG ON VALVE ASSEMBLY

(71) Applicant: Worthington Enterprises Inc., Columbus, OH (US)

(72) Inventors: Edward Richard YOHO, Columbus, OH (US); Chase EVANS, Marysville, OH (US)

(21) Appl. No.: 19/062,672

(22) Filed: Feb. 25, 2025

Related U.S. Application Data
(60) Provisional application No. 63/557,844, filed on Feb. 26, 2024.

(51) Int. Cl. F17C 13/04

(52) U.S. Cl. CPC F17C 13/04; F17C 2201/0109; F17C 2201/018; F17C 2201/032; F17C 2203/0631; F17C 2205/0305; F17C 2205/0332; F17C 2205/0352; F17C 2223/033

(57) ABSTRACT

A storage container includes a body that defines an interior of the storage container. The body includes a top end and a bottom end opposite the top end, and a spud coupled to the top end of the body. The spud includes an outer surface and an inner surface. The inner surface includes a lower ledge extending inwards from the inner surface of the spud, and a retaining ring groove extending into the spud, wherein the retaining ring groove is positioned above the lower ledge. A retaining ring is removeably inserted into the retaining ring groove such that the retaining ring extends inward from the inner surface of the spud. The storage container further includes a cover plate nested within the inner surface of the spud and retained within a vertical gap between the lower ledge of the spud and the retaining ring.

### RELATED APPLICATION DATA

This application claims priority to U.S. Provisional Patent Application No. 63/557,844 filed Feb. 26, 2024, which is incorporated herein by reference in its entirety.

### TECHNICAL FIELD

In general, the present invention relates to a portable storage cylinder, and in particular, to a portable storage cylinder including one or more inner bags that contains a material for dispensing.

### BACKGROUND OF THE INVENTION

A variety of storage containers have been used that incorporate an inner bag or bladder for containing a material. However, attachment methods of the inner bag or bladder to the surrounding storage container and/or valve can create points of failure, especially in situations where the container is dropped or is subject to a force. Further, certain dispensing applications require multiple materials to be dispensed. A safe, convenient storage and dispensing solution is desired.

### SUMMARY OF THE INVENTION

In accordance with an embodiment of the present invention, a storage container includes a body that defines an interior of the storage container. The body includes a top end and a bottom end opposite the top end, and a spud coupled to the top end of the body. The spud includes an outer surface and an inner surface. The inner surface includes a lower ledge extending inwards from the inner surface of the spud, and a retaining ring groove extending into the spud, wherein the retaining ring groove is positioned above the lower ledge. A retaining ring is removeably inserted into the retaining ring groove such that the retaining ring extends inward from the inner surface of the spud. The storage container further includes a cover plate nested within the inner surface of the spud and retained within a vertical gap between the lower ledge of the spud and the retaining ring while the retaining ring is inserted into the retaining ring groove of the spud.

These and other objects of this invention will be evident when viewed in light of the drawings, detailed description and appended claims.

### BRIEF DESCRIPTION OF THE DRAWINGS

The invention may take physical form in certain parts and arrangements of parts, a preferred embodiment of which will be described in detail in the specification and illustrated in the accompanying drawings which form a part hereof, and wherein:

FIG. 1 is a top perspective view of an exemplary storage container.

FIG. 2 is a top view of an exemplary storage container.

FIG. 3A is a cross-section view of an exemplary storage container.

FIG. 3B is an enlarged detailed cross-section view of a cover plate of an exemplary storage container.

FIG. 3C is a cross-sectional view of an exemplary storage container.

FIG. 3D is an enlarged detailed cross-section view of a cover plate of an exemplary storage container.

FIG. 4A is a top view of an exemplary cover plate.

FIG. 4B is a cross-sectional view of an exemplary cover plate.

FIG. 5A is a top view of an exemplary spud.

FIG. 5B is a cross-sectional view of an exemplary spud.

FIG. 5C is an enlarged detailed cross-section view of an exemplary spud.

FIG. 6A is a perspective view of an exemplary retaining ring.

FIG. 6B is a perspective view of another exemplary retaining ring.

FIG. 7A is a top view of an exemplary hose fitting.

FIG. 7B is a cross-sectional view of an exemplary hose fitting.

FIG. 8A is a top view of an exemplary cover plate.

FIG. 8B is a cross-sectional view of an exemplary cover plate.

FIG. 9A is a bottom perspective view of an exemplary plate having two valves.

FIG. 9B is a perspective view of an exemplary storage container having two valves.

FIG. 10A is a top view of an exemplary bag.

FIG. 10B is a top view of two exemplary bags.

FIG. 11A is a top view of an exemplary multi-chamber bag.

FIG. 11B is an enlarged detailed view of an exemplary multi-chamber bag.

FIG. 12 is a perspective view of an exemplary storage container having two valves.

### DETAILED DESCRIPTION OF THE INVENTION

Embodiments of the invention include methods and systems related to a storage container having a body, a material valve, and one or more internal bags or bladders configured to contain a material. The storage container can include a chamber configured to internally store a compressed gas, such as air, or a propellant material such as a refrigerant, in a space between the bag/bladder and the body. A user can dispense the material out of the one or more bags or bladders, through a hose and material valve (or directly through the material valve in embodiments without a hose), into an exterior environment. The compressed gas or propellant material can act as a propellant in dispensing the material to the exterior environment. A spud coupled to the top of the body can have an inner surface with a lower ledge and a retaining ring groove above the lower ledge. A retaining ring can be removeably inserted into the retaining ring groove such that the retaining ring extends inward from the inner surface of the spud. A cover plate can nest within the spud and be retained between the lower ledge and the retaining ring. The material valve and/or a barbed sleeve can be coupled to the cover plate. When the storage container is pressurized, the internal pressure of the storage container applies a force pushing the cover plate upwards into the retaining ring, securing the cover plate in place and preventing user removal of the retaining ring and the cover plate due to the blocking feature and friction provided by the retaining ring, which obstructs the retaining ring removal. When the storage container is depressurized, a user may push down the cover plate and/or gravity pulls down the cover plate, and the user may remove the retaining ring and subsequently the cover plate in order to safely and conveniently replace the contents of the storage container (e.g. by way of replacing a bag or bladder). Certain embodiments can allow for two bags of material within the same storage container, corresponding to one or more valves for dispensing the material within the bags.

With reference to the drawings, like reference numerals designate identical or corresponding parts throughout the several views. However, the inclusion of like elements in different views does not mean a given embodiment necessarily includes such elements or that all embodiments of the invention include such elements. The examples and figures are illustrative only and not meant to limit the invention, which is measured by the scope and spirit of the claims.

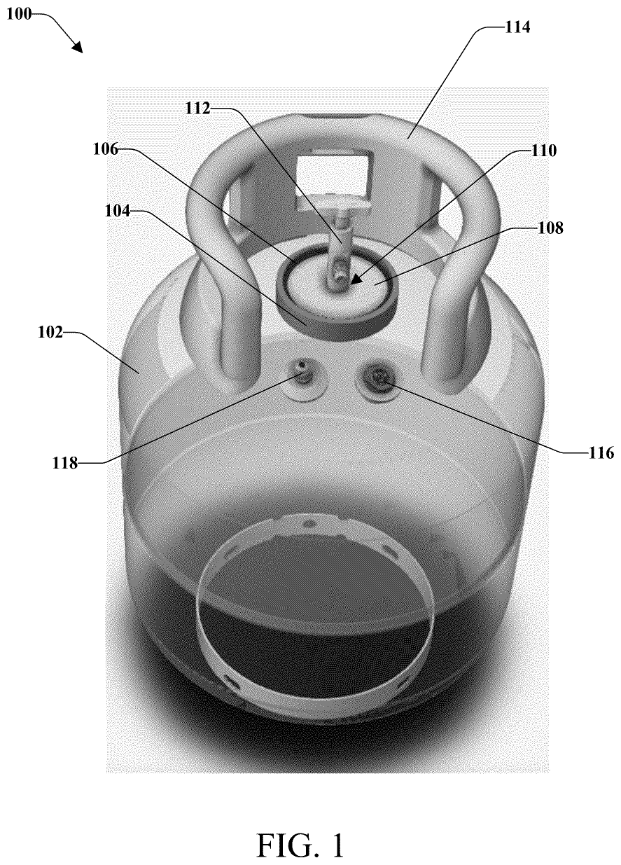

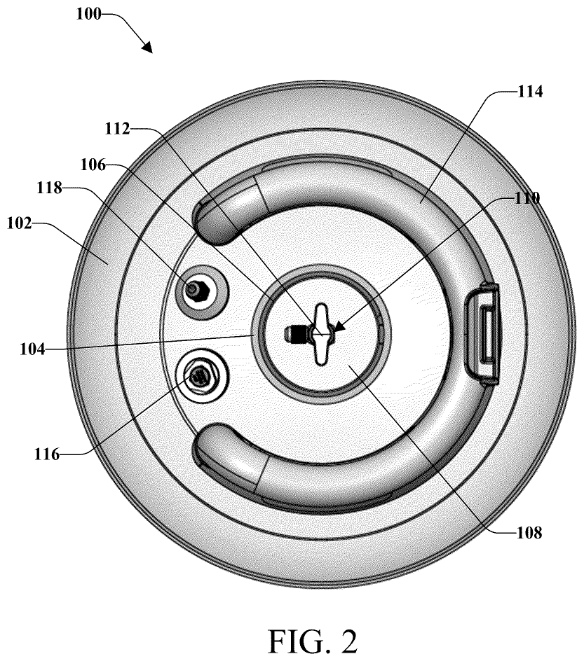

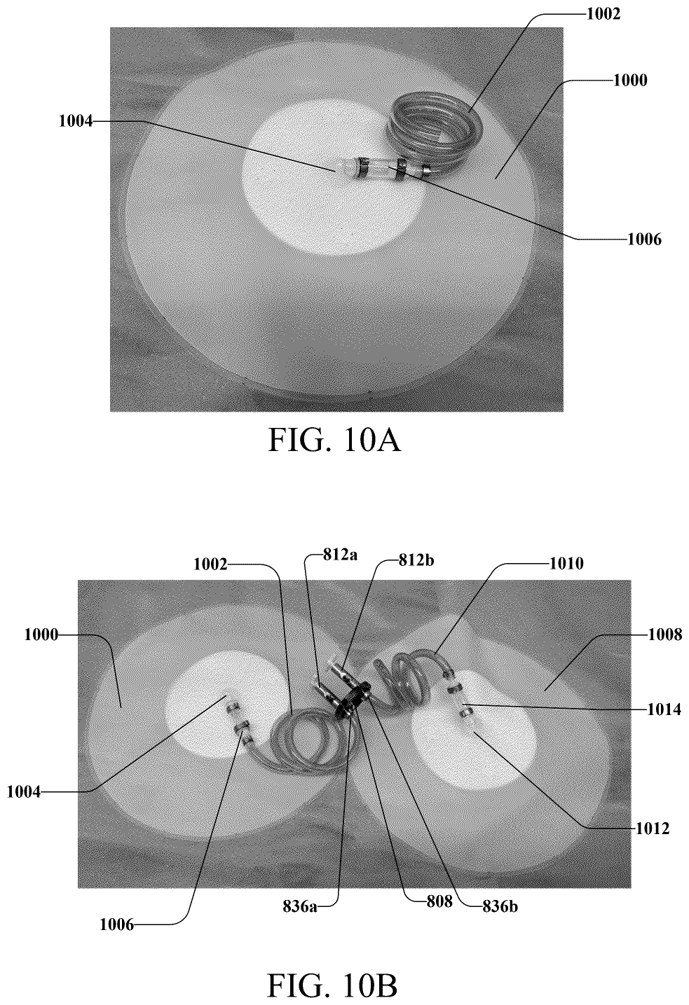

Turning now to FIGS. 1 and 2, a storage container 100 is shown. The storage container 100 can include a top, a bottom opposite the top, and a cylindrical sidewall connecting the top and bottom, where the cylindrical sidewall has a length. The storage container 100 includes a body 102 that can be constructed of or fabricated with any material chosen using sound engineering judgment. By way of example, and not limitation, the body 102 can be constructed using one or more of metal, such as steel or aluminum, carbon fiber, glass fiber, a plastic, a composite material such as metal combined with plastic, or a polymer such as high density polyethylene. The body 102 defines an interior space within the storage container 100. Located within the interior space of the storage container is one or more bags (e.g. the bag 1000 as shown in FIG. 10A and described in greater detail below). It should be appreciated that the term bag as used herein can mean a bag, a bladder, or any other enclosed structure capable of containing a fluid. At the top end of the body 102, the storage container 100 includes a spud 104. In certain embodiments, the spud 104 can be cylindrical. A retaining ring 106 can be removeably inserted within the spud 104 such that the retaining ring 106 extends inward from the inner surface of the spud 104. A cover plate 108 is nested within the spud 104 and retained beneath the retaining ring 106, which extends inwards to cover at least a portion of the cover plate 108. The cover plate 108 can include an aperture 110 through which a material valve 112 can extend to provide selective fluid communication between the interior of the storage container 100 and the exterior environment.

Further, the storage container 100 can include one or more handles 114 configured to allow a user to grip and carry the storage container 100. The one or more handles 114 also provide protection to the material valve 112 in the event that the storage container 100 is dropped. In certain embodiments, the storage container 100 can also include a pressure relief device 116 for venting excess pressure and a propellant valve 118 for adding or venting the contents of the storage container 100 surrounding the bag 1000. For example, the propellant valve 118 can be used to add or remove a compressed gas such as air and/or propellant materials.

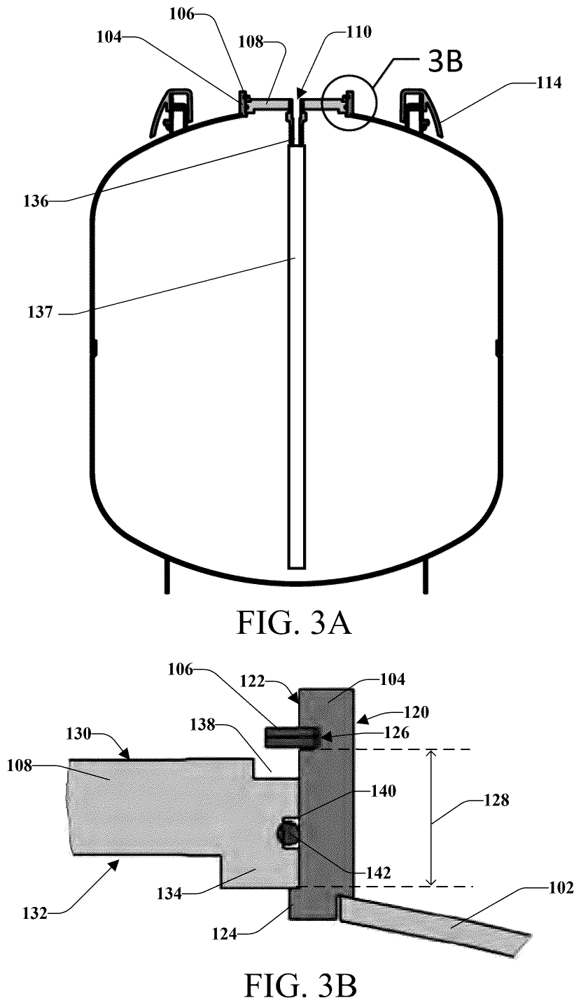

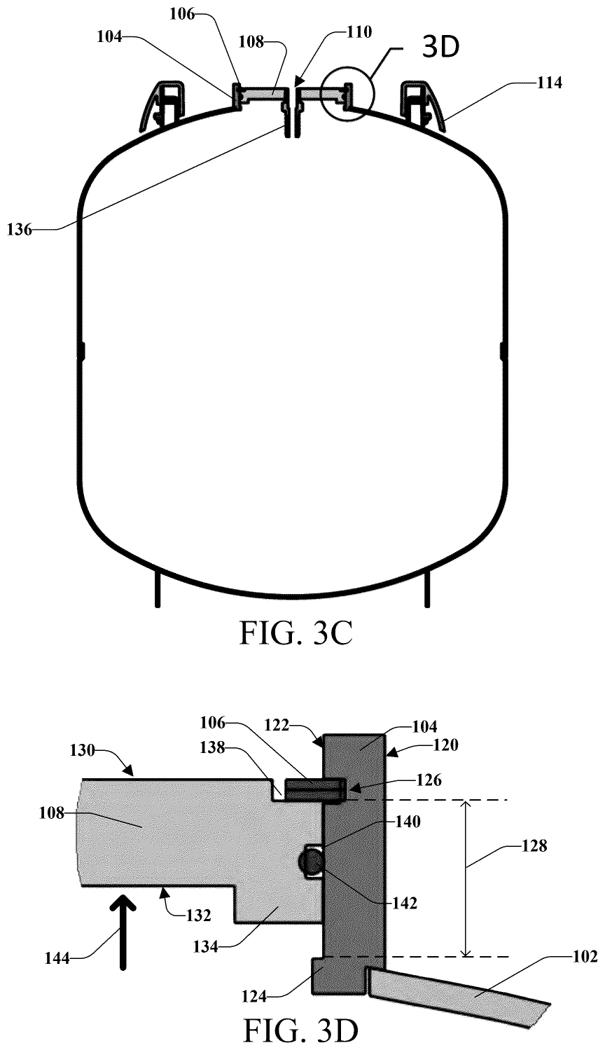

Turning now to FIGS. 3A and 3B, a cross-sectional view of the storage container 100 with no internal pressure is shown, with enlarged details shown in FIG. 3B. In certain embodiments, the spud 104 can be cylindrical. The spud 104 can include an outer surface 120 and an inner surface 122. The inner surface 122 of the spud 104 can include a lower ledge 124 that extends inwards from the inner surface 122. The inner surface 122 can also include a retaining ring groove 126 that extends into the body of the spud 104. The retaining ring groove 126 is positioned above the lower ledge 124. A retaining ring 106 can be removeably inserted within the retaining ring groove 126 such that the retaining ring 106 extends inward from the inner surface of the spud creating a vertical gap 128 between the lower ledge 124 and the retaining ring 106.

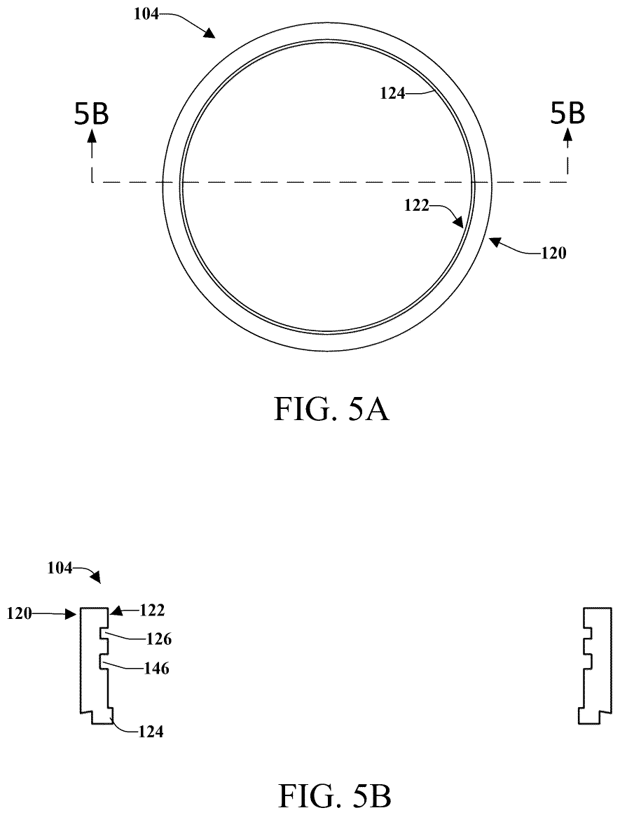

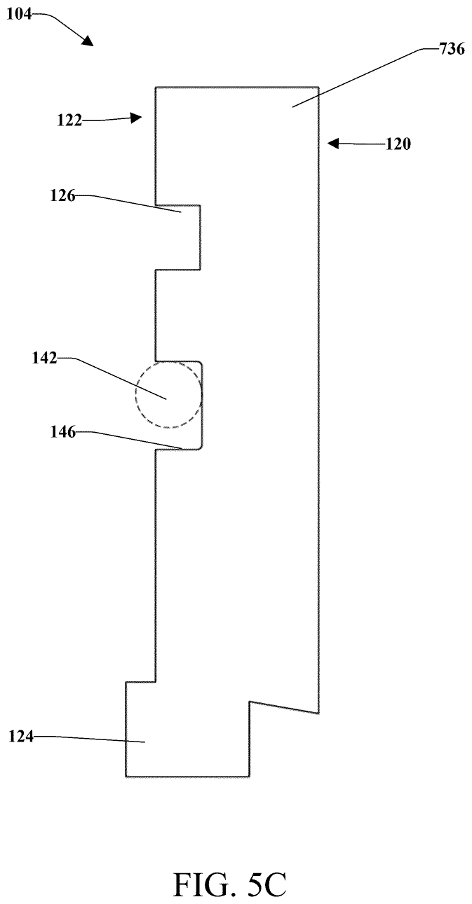

A cover plate 108 can nest within the spud 104. While nested within the spud 104, the cover plate 108 is retained within the vertical gap 128 between the lower ledge 124 of the spud 104 and the retaining ring 106 while the retaining ring 106 is inserted into the retaining ring groove 126 of the spud 104. In certain embodiments, the vertical gap 128 has a height greater than the thickness of the cover plate 108. The cover plate 108 has a shape corresponding to the opening in the spud 104. For example, if the spud 104 is cylindrical in shape, then the cover plate 108 is circular in cross-section. The cover plate 108 can have an upper surface 130, a lower surface 132, and a rim 134 that extends around the circumference of the cover plate 108. The aperture 110 extends through the upper surface 130 and lower surface 132 and can be coupled with the material valve 112 and a hose fitting 136 configured to couple with a hose leading to a bag 1000. The hose fitting 136 can be, for example, a barb, a friction fit, a clamp, or a quick-connect, among others. In certain embodiments, a diptube 137 can be coupled to the cover plate 108 by, for example, connecting to the hose fitting 136. The diptube 137 can extend into the interior of the storage container and, in some embodiments, extend into a bag 1000. In certain embodiments, the rim 134 can be vertically offset lower than the upper surface 130 of the cover plate 108 to create an upper notch 138. Further, in certain embodiments, the edge of the rim 134 can include a seal slot 140 extending around the circumference of the rim 134. The seal slot 140 can provide space to receive a seal 142 such as an O-ring to create a seal between the cover plate 108 and the spud 104. It should be appreciated that instead of the seal slot 140 being included on the cover plate 108, the seal slot 140 could alternatively be included on the inner surface 122 of the spud 104 as shown in FIG. 5C.

As shown in FIG. 3B, when there is no internal pressure within storage container 100 (e.g. due to compressed gas and/or propellant material within the storage container 100), a portion of the rim 134 of the cover plate 108 may rest on the lower ledge 124 of the spud 104. While the cover plate 108 is in this position, the cover plate 108 does not contact or apply pressure to the retaining ring 106. It should be appreciated that a threshold pressure within the storage container 100 is required in order to provide the force necessary to move the cover plate 108 upwards to contact the retaining ring 106. Accordingly, even with a small amount of pressure within the storage container 100, the cover plate 108 may not be lifted within the vertical gap 128 if the amount of pressure is less than the threshold pressure. In certain embodiments, the threshold pressure is less than 90 pounds per square inch (psi), but greater than 0 psi. In certain embodiments, the threshold is less than 15 psi but greater than 0 psi. In certain embodiments, the threshold pressure is less than 5 psi, but greater than 0 psi.

Turning now to FIGS. 3C and 3D, a cross-sectional view of the storage container 100 having an internal pressure greater than the threshold pressure is shown, with enlarged details shown in FIG. 3D. When the internal pressure within the storage container 100 (e.g. due to compressed gas and/or propellant material within the storage container 100) exceeds the threshold pressure, the internal pressure provides an upward force 144 on the lower surface 132 of the cover plate 108, causing the cover plate 108 to move upwards within the gap 128 and the rim 134 to contact and press upwards against the retaining ring 106. In either position (cover plate 108 resting on the lower ledge 124, or cover plate 108 forced upwards against the retaining ring 106), or any position in between, the seal 140 maintains a seal between the cover plate 108 and the inner surface 122 of the spud 104 to prevent any of the contents of the storage container 100 from escaping. In certain embodiments, the upper notch 138 can have a depth so that the top of the retaining ring 106 is level with the upper surface 130 of the cover plate 130 when the rim 134 is pressed upward against the retaining ring 106. In other embodiments, the upper notch 138 can have a depth so that the top of the retaining ring 106 sits below the upper surface 130 of the cover plate 108 when the rim 134 is pressed upward against the retaining ring 106.

As the internal pressure increases within the storage container 100, the force of the cover plate 108 pushing upwards against the retaining ring 106 increases and further secures the retaining ring in place. The extra upward force provided by the cover plate 108 pushing against the retaining ring 106 makes it difficult or impossible for a user to remove the retaining ring 106 and therefore makes it difficult or impossible for a user to disassemble the cover plate 108 from the spud 104 if the internal pressure is above a pressure threshold. This feature ensures that any propellant material (e.g. refrigerant) inside the storage container 100 is returned to a storage container 100 refiller and can be reclaimed/re-used, and also prevents safety issues and environmental issues created by a user removing the cover plate 108 while the storage container 100 is pressurized, thus preventing injury to the user and environmental contamination caused by the release of pressurized propellant material.

In one example, a user may receive a pre-pressurized storage container 100. In such a condition, the cover plate 108 is in the position shown in FIG. 3D, and therefore the upwards force of the cover plate 108 on the retaining ring 106 prevents the user from removing the retaining ring 106 or the cover plate 108. After the contents of a bag 1000 internal to the storage container 100 is dispensed, a residual internal pressure (e.g. 90 psi) may remain within the storage container 100 due to leftover propellant material and/or compressed gas. This residual internal pressure can still provide enough upward force 144 on the cover plate 108 to keep the cover plate pressed up against the retaining ring 106. In order for the user to be able to remove the retaining ring 106 and the cover plate 108, the user must properly depressurize the tank, for example, via the propellant valve 118. Once depressurized below a pressure threshold at which the upward force 144 of the internal pressure on the cover plate 108 is low enough for either the cover plate 108 to fall and rest on the lower ledge 124, or the user to push down the cover plate 108 to rest on the lower ledge 124, the user may then remove the retaining ring 106 from the retaining ring groove 126, and remove the cover plate 108, as well as anything else attached to the cover plate 108 (e.g. hose fitting 136, bag 1000, etc.).

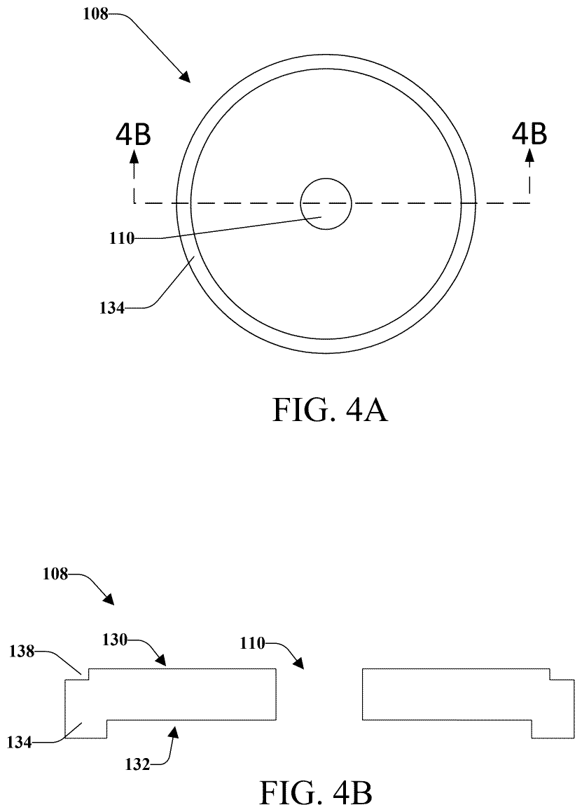

Turning now to FIGS. 4A and 4B, an exemplary cover plate 108 is shown. As shown, the cover plate 108 includes an upper surface 130, a lower surface 132, an aperture 110, and a rim 134 extending around the circumference of the cover plate 108 as previously described. In the embodiment shown in FIGS. 4A and 4B, the rim is offset lower than central portion of the cover plate 108, which creates the upper notch 138.

FIGS. 5A and 5B depict an exemplary spud 104. As shown, the spud 104 is cylindrical, having an inner surface 122 and an outer surface 120. The spud 104 couples to the top of the storage container 100 body 102 and provides a physical interface for connecting the material valve 112. The spud 104 can be coupled with the body 102 by way of, for example, a threaded connection, or a welded connection, among others. As previously described, the inner surface 122 of the spud 104 can include a lower ledge 124 that extends inwards from the inner surface 122. The inner surface 122 can also include a retaining ring groove 126 that extends into the body of the spud 104. The retaining ring groove 126 is positioned above the lower ledge 124. In the embodiment shown in FIGS. 5A and 5B, the inner surface 122 of the spud 104 includes a seal slot 146 extending around the circumference of the inner surface 122 of the spud 104. As shown in the enlarged detail view of FIG. 5C, the seal slot 146 can provide space to receive a seal 142 such as an O-ring to create a seal between the cover plate 108 and the inner surface 122 of the spud 104. It should be appreciated that the storage container 100 can include either the seal slot 140 on the cover plate 108 or the seal slot 146 on the spud 104 for retaining the seal 142.

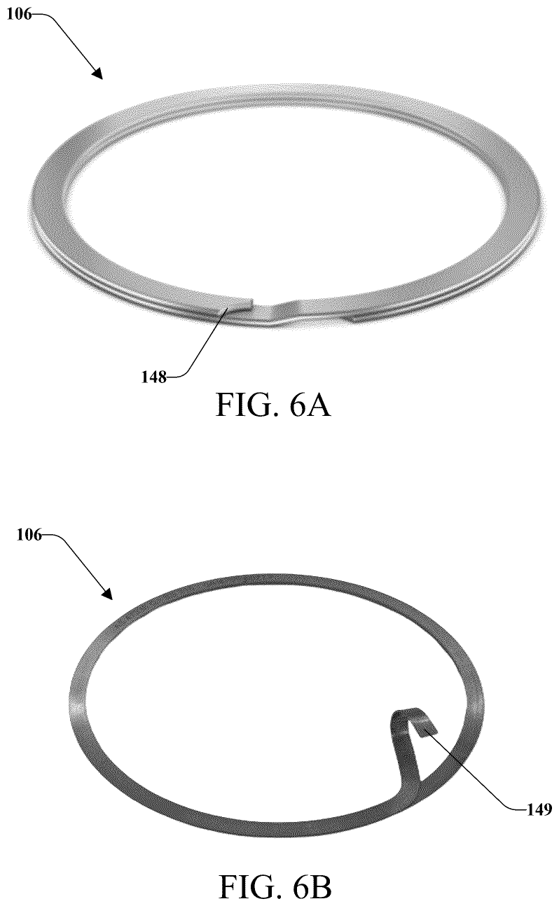

Turning now to FIG. 6A, an exemplary retaining ring 106 is shown. It should be appreciated that the retaining ring 106 can be any appropriate type of retaining ring 106 selected using sound engineering judgment. In one embodiment, the retaining ring 106 is a spiral retaining ring that can be expanded and compressed similar to a coiled spring. Similarly, the retaining ring 106 can have an initial diameter and can be compressed inwards to temporarily reduce the diameter of the retaining ring 106 to allow for insertion of the retaining ring 106 into the retaining ring groove 126 of the spud 104. Once the retaining ring 106 is inserted and released within the retaining ring groove 126, the retaining ring 106 expands to its initial diameter to better sit within the retaining ring groove 126. The retaining ring 106 should have enough strength to resist and support the thrust load of the cover plate 108 being pushed upwards by the upward force 144 caused by the internal pressure of the storage container 100. In certain embodiments, the retaining ring 106 can include a cutout 148. The cutout 148 can provide a space in which a tool such as a screwdriver can be inserted to assist in removing the retaining ring 106 from the retaining ring groove 126.

In another embodiment shown in FIG. 6B, the retaining ring 106 can also include a tab 149 that extends vertically perpendicular to the plane of the retaining ring 106. The tab 149 can also include a loop or hook on its end. The tab 149 provides a feature that a user can grasp with a hand, a tool, or an automated tool to assist with removing the retaining ring 106 from the spud 104.

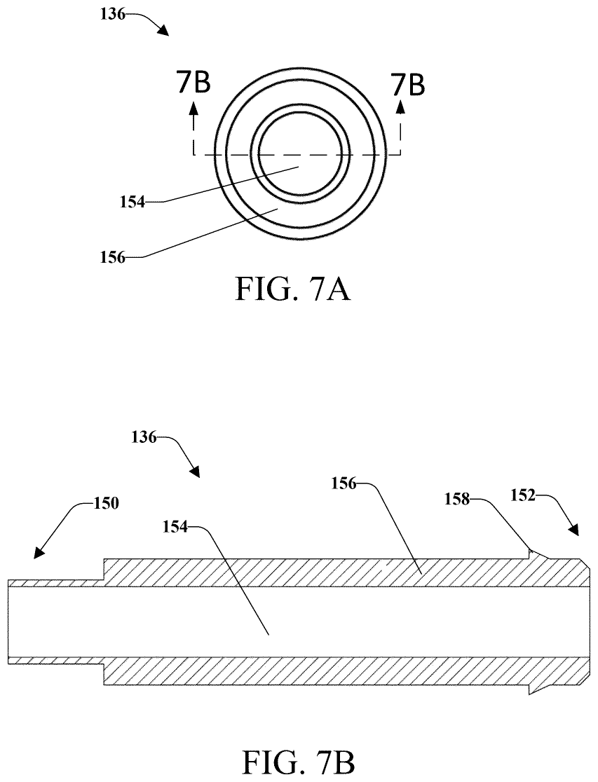

Turning now to FIGS. 7A and 7B, a hose fitting 136 is shown. The hose fitting 136 can include a first end 150 opposite a second end 152. The hose fitting 136 can further include a central channel 154 surrounded by a sleeve 156, which can include one or more barbs 158 extending from the outside of the sleeve 152. The first end 150 of the hose fitting 136 is configured to couple with or extend through the aperture 110 of the cover plate 108. The material valve 112 can couple to the first end 150 of the hose fitting 136. The second end 152 of the hose fitting 136 can extend into the interior of the body 102. A hose 1002 and/or bag 1000 (as shown, e.g. in FIG. 10A) can couple to the second end of the hose fitting 136, where the one or more barbs 158 prevent the hose 1002 and/or bag 1000 from being removed from the hose fitting 136.

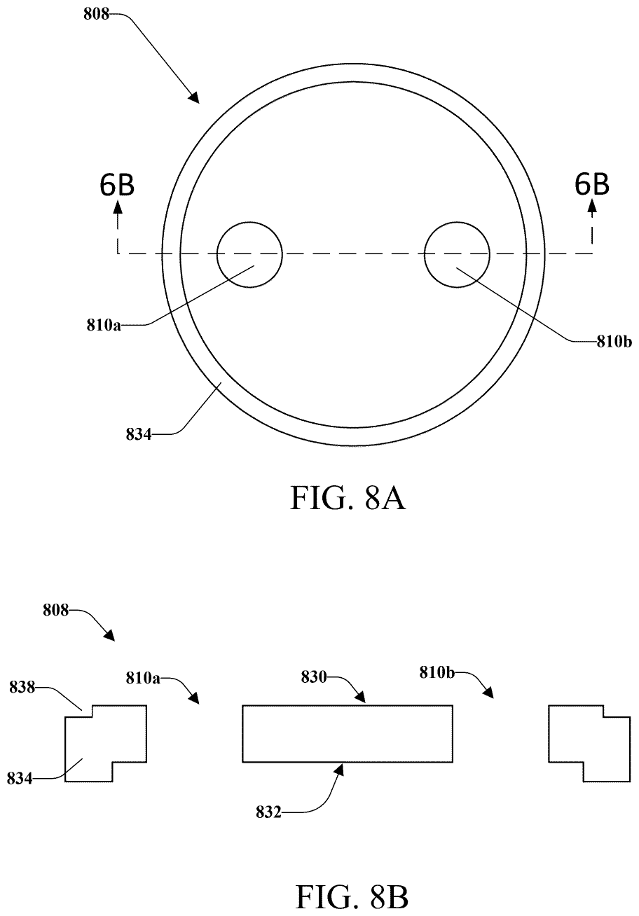

As further described herein, certain embodiments of storage containers 100 can include more than one bag within the body 102. Certain applications and use cases of the storage container 100 require the usage of two different materials. In these cases, a storage container 100 containing two bags, each containing different materials, can be employed. Turning to FIG. 8A and 8B, a cover plate 808 is shown. Similar to cover plate 108, cover plate 808 includes an upper surface 830, a lower surface 832, and a rim 834 extending around the circumference of the cover plate 808. In the embodiment shown in FIGS. 8A and 8B, the rim 834 is offset lower than the central portion of the cover plate 808, which creates the upper notch 838. However, cover plate 808 includes two apertures—a first aperture 810a and a second aperture 810b.

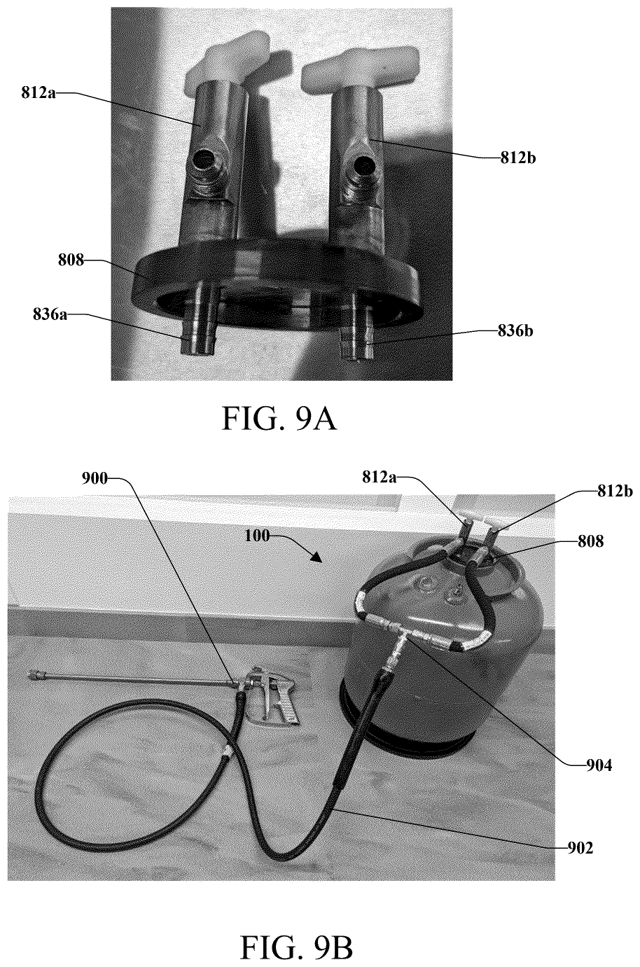

FIG. 9A depicts a cover plate 808, which further includes a first hose fitting 836a extending through the first aperture 810a and coupled to a first material valve 812a. Similarly, a second hose fitting 836b extends through the second aperture 810b and is coupled to a second material valve 812b.

FIG. 9B shows the cover plate 808 coupled with storage container 100. The first material valve 812a and the second material valve 812b are both coupled to a dispenser 900 via a dispensing hose 902. The dispenser 900 can be, for example, an applicator, a nozzle, or a spray gun, among others. As shown, the dispensing hose 902 is coupled to a T-connector 904, which is independently coupled to each of the first material valve 812a and the second material valve 812b. In this manner, a user can select one of two bags (corresponding to each of the first material valve 812a and the second material valve 812b) from which to dispense material. In certain embodiments, a single selector valve can be used instead of a first material valve 812a and second material valve 812b. The selector valve can be actuated into a first position to select control of dispensing from the first bag 1000, a second position to select control of dispensing from the second bag 1008, and optionally, a third position to disconnect the selector valve from both bags. After the selector valve is actuated to select between a first bag 1000 or a second bag 1008, the user can operate the valve to begin dispensing from the selected bag as controlled by the dispenser 900. It should be appreciated that in embodiments containing a selector valve, a T-connector 904 may be omitted and the hose 902 can have a direct connection between the selector valve and the dispenser 900.

In one embodiment, the first bag 1000 can contain an application material for application to a substrate and the second bag 1008 can contain a cleaning solution. For example, the application material can be an adhesive material, or an insulating material such as a foam, and the cleaning solution can be water, a water-based cleaner, a solvent, a commercially available cleaner, a solution containing soap, among others. A user can select dispensing from the first bag 1000 by opening the first material valve 812a or by actuating the selector valve into the first position. The user can then utilize the dispenser 900 (e.g. pressing a trigger) to apply the application material as needed. After application of the application material is completed, the user can then select dispensing from the second bag 1008 by closing the first material valve 812a and opening the second material valve 812b, or by actuating the selector valve into the second position. The user can then utilize the dispenser 900 to dispense the cleaning solution from the second bag 1008. The cleaning solution flows through the hose 902, through the dispenser 900, and out of the dispenser 900, and functions to purge the hose 902 of the application material and clean the inside of the hose 902 as well as purge and clean the application material from the inside of the dispenser 900. This process avoids the use of excessive water and the inconvenience of cleaning the re-usable equipment at an external source of water or other cleaning fluid.

Turning now to FIG. 10A, an exemplary bag 1000 is shown. The bag 1000 can be constructed of a single layer or multiple layers of one or more of a plastic, a foil, a metalized material, a non-metalized material, polyurethane, an elastomer such as thermoplastic polyurethane (TPU), ethylene-vinyl acetate (EVA), or flexible polyvinyl chloride (PVC), among others. The bag 1000 can be fluidly coupled to the hose fitting 136 and/or material valve 112 by way of a hose 1002. The hose 1002 can include a first end coupled to the hose fitting 136 or material valve 112 and a second end coupled to the bag 1000. In certain embodiments, the second end of the hose 1002 can be coupled directly to the bag 1000 by, for example, a weld or an adhesive, among other methods. In other embodiments, the second end of the hose 1002 is coupled to the bag 1000 via a spout 1004. The spout 1004 can include a flange portion configured to be coupled to the opening of a bag 1000. For example, the flange portion can be adhered or welded to the corresponding opening of the bag 1000. In certain embodiments, the spout 1004 can also include a tube coupling portion 1006 configured to receive the hose 1002. The tube coupling portion 1006 can be, for example, a barb, a friction fit, a clamp, or a quick-connect, among others. In other embodiments, the hose 1002 is welded directly to the tube coupling portion 1006. The spout 1004 can be constructed of a flexible material, and may be made of the same material as the bag 1000 such that the spout 1004 is able to flex and bend with the bag 1000. For example, the spout 1004 can be made of thermoplastic polyurethane (TPU), ethylene vinyl acetate (EVA), or flexible polyvinyl chloride (PVC), among others. The bag 1000 can be collapsed or folded to be substantially flat when empty, as shown in FIG. 10A. When the bag 1000 is filled with material, the bag 1000 can expand to accommodate a volume of material.

FIG. 10B depicts an embodiment that includes two bags. In addition to the first bag 1000 (coupled to the first hose fitting 836a via the hose 1002) and its corresponding components and connections described above, a second bag 1008 is also coupled to the second hose fitting 836b, and is operable via the second material valve 812b. The second bag 1008 can be fluidly coupled to the second hose fitting 836b and/or second material valve 812b by way of a second hose 1010. The second hose 1010 can include a first end coupled to the second hose fitting 136b or second material valve 112b and a second end coupled to the second bag 1008. In certain embodiments, the second end of the second hose 1010 can be coupled directly to the second bag 1008 by, for example, a weld or an adhesive, among other methods. In other embodiments, the second end of the second hose 1010 can be coupled to the second bag 1008 via a second spout 1012. The second spout 1012 can include a flange portion configured to be coupled to the opening of a second bag 1008. For example, the flange portion can be adhered or welded to the corresponding opening of the second bag 1008. In certain embodiments, the second spout 1012 can also include a second tube coupling portion 1014 configured to receive the second hose 1010. The second tube coupling portion 1014 can be, for example, a barb, a friction fit, a clamp, or a quick-connect, among others. In other embodiments, the second hose 1010 is welded directly to the second tube coupling portion 1014. The second spout 1012 can be constructed of a flexible material, and may be made of the same material as the bag 1000 such that the second spout 1012 is able to flex and bend with the second bag 1008. For example, the second spout 1012 can be made of thermoplastic polyurethane (TPU), ethylene vinyl acetate (EVA), or flexible polyvinyl chloride (PVC), among others. The second bag 1008 can be collapsed or folded to be substantially flat when empty, as shown in FIG. 10B. When the second bag 1008 is filled with material, the second bag 1008 can expand to accommodate a volume of material. Both the first bag 1000 and the second bag 1008 can be inserted into a storage container 100. In certain embodiments, the first bag 1000 and the second bag 1008 contain the same materials. In other embodiments, the first bag 1000 and the second bag 1008 contain different materials.

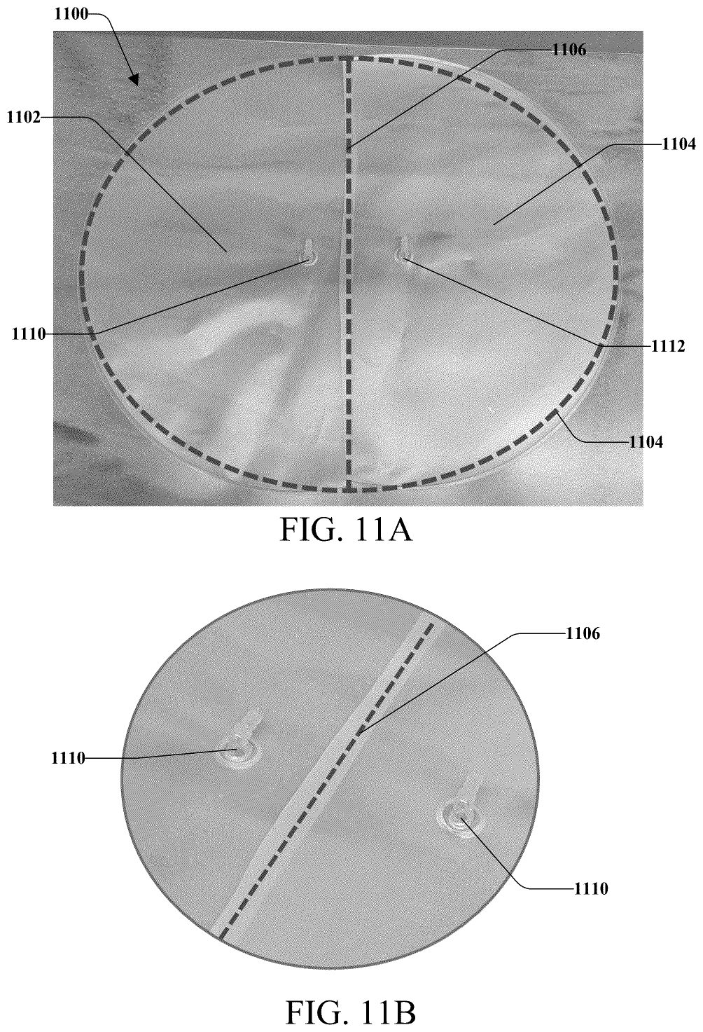

Turning now to FIGS. 11A and 11B, a multi-chambered bag 1100 is shown. The multi-chambered bag 1100 is divided into a first bag 1102 and a second bag 1104, which are separated by a separation weld 1106. An outer circumference of the multi-chambered bag 1100 is sealed by way of a perimeter weld 1108. The first bag 1102 and the second bag 1104 are connected along a common seam created, for example, by the separation weld 1106. In one embodiment, the first bag 1102 is a separate bag from the second bag 1104, and the two bags are arranged adjacent to one another and connected by the separation weld 1106. In another embodiment, a top sheet is laid on top of a bottom sheet. The separation weld 1106 can be applied to separate the one large chamber created by the top sheet and the bottom sheet into the first bag 1102 and the second bag 1104. It should be appreciated that, in the process of creating the first bag 1102 and the second bag 1004, the perimeter weld 1108 can be applied before the separation weld 1106 or after the separation weld 1106.

In certain embodiments, the first bag 1102 and the second bag 1104 contain the same materials. In other embodiments, the first bag 1102 and the second bag 1104 contain different materials. The first bag 1102 can include a first spout 1110 and the second bag 1104 can include a second spout 1112, each for the respective connections to the respective material valves 812a, 812b, via the respective hose fittings 836a, 836b, and hoses 1002, 1010. It should be appreciated that the multi-chambered bag 1100 can be constructed of thermoplastic polyurethane (TPU), ethylene vinyl acetate (EVA), or flexible polyvinyl chloride (PVC), among others. In one embodiment, the first bag 1102 and the second bag 1104 are made of the same material. In another embodiment, the first bag 1102 is made of a first material and the second bag 1104 is made of a different second material.

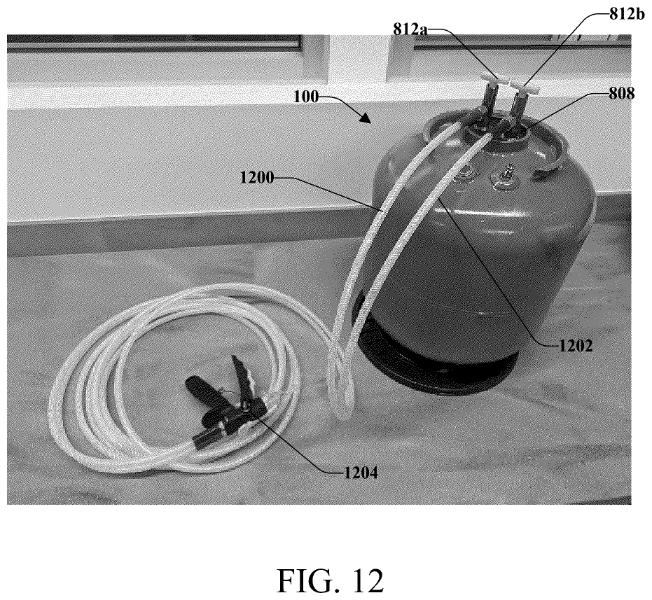

FIG. 12 depicts another embodiment of a storage container 100. Similar to the storage container 100 depicted in FIG. 9B, the storage container 100 can include a two-valve arrangement. However, in this embodiment, a first dispenser hose 1200 is attached to the first material valve 812a at its first end, and attached to a dispenser 1204 at its second end, and a second dispenser hose 1202 is attached to the second material valve 812b at its first end, and attached to the dispenser 1204 at its second end. In certain embodiments, the first bag 1000 and the second bag 1008 can contain different materials that are configured to mix together at the dispenser 1204 prior to application via the dispenser 1204. In these embodiments, both the first material valve 812a and the second material valve 812b may be opened. Upon activation of the dispenser 1204 (e.g. by operating a trigger), the material in both bags is dispensed and mixes together at the dispenser 1204. In one embodiment, the first bag 1000 contains a first component of a two-component adhesive and the second bag 1008 contains a second component of a two-component adhesive. In another embodiment, the first bag 1000 contains a first component of a two-component foam and the second bag 1008 contains a second component of a two-component foam.

The aforementioned systems, components, and the like have been described with respect to interaction between several components and/or elements. It should be appreciated that such devices and elements can include those elements or sub-elements specified therein, some of the specified elements or sub-elements, and/or additional elements. Further yet, one or more elements and/or sub-elements may be combined into a single component to provide aggregate functionality. The elements may also interact with one or more other elements not specifically described herein.

While the embodiments discussed herein have been related to the systems and methods discussed above, these embodiments are intended to be exemplary and are not intended to limit the applicability of these embodiments to only those discussions set forth herein.

The above examples are merely illustrative of several possible embodiments of various aspects of the present invention, wherein equivalent alterations and/or modifications will occur to others skilled in the art upon reading and understanding this specification and the annexed drawings. In particular regard to the various functions performed by the above described components, the terms (including a reference to a “means”) used to describe such components are intended to correspond, unless otherwise indicated, to any component, which performs the specified function of the described component (e.g., that is functionally equivalent), even though not structurally equivalent to the disclosed structure which performs the function in the illustrated implementations of the invention. In addition, although a particular feature of the invention may have been disclosed with respect to only one of several implementations, such feature may be combined with one or more other features of the other implementations as may be desired and advantageous for any given or particular application. Also, to the extent that the terms “including”, “includes”, “having”, “has”, “with”, or variants thereof are used in the detailed description and/or in the claims, such terms are intended to be inclusive in a manner similar to the term “comprising.”

This written description uses examples to disclose the invention, including the best mode, and also to enable one of ordinary skill in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that are not different from the literal language of the claims, or if they include equivalent structural elements with insubstantial differences from the literal language of the claims.

In the specification and claims, reference will be made to a number of terms that have the following meanings. The singular forms “a”, “an” and “the” include plural referents unless the context clearly dictates otherwise. Approximating language, as used herein throughout the specification and claims, may be applied to modify a quantitative representation that could permissibly vary without resulting in a change in the basic function to which it is related. Accordingly, a value modified by a term such as “about” is not to be limited to the precise value specified. In some instances, the approximating language may correspond to the precision of an instrument for measuring the value. Moreover, unless specifically stated otherwise, a use of the terms “first,” “second,” etc., do not denote an order or importance, but rather the terms “first,” “second,” etc., are used to distinguish one element from another.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances the modified term may sometimes not be appropriate, capable, or suitable. For example, in some circumstances an event or capacity can be expected, while in other circumstances the event or capacity cannot occur-this distinction is captured by the terms “may” and “may be.”

The best mode for carrying out the invention has been described for purposes of illustrating the best mode known to the applicant at the time and enable one of ordinary skill in the art to practice the invention, including making and using devices or systems and performing incorporated methods. The examples are illustrative only and not meant to limit the invention, as measured by the scope and merit of the claims. The invention has been described with reference to preferred and alternate embodiments. Modifications and alterations will occur to others upon the reading and understanding of the specification. It is intended to include all such modifications and alterations insofar as they come within the scope of the appended claims or the equivalents thereof. The patentable scope of the invention is defined by the claims, and may include other examples that occur to one of ordinary skill in the art. Such other examples are intended to be within the scope of the claims if they have structural elements that do not differentiate from the literal language of the claims, or if they include equivalent structural elements with insubstantial differences from the literal language of the claims.

What is claimed is:

1. A storage container comprising:
a body that defines an interior of the storage container, wherein the body includes a top end and a bottom end opposite the top end;
a spud coupled to the top end of the body, wherein the spud includes an outer surface and an inner surface, the inner surface comprising:
a lower ledge extending inwards from the inner surface of the spud, and
a retaining ring groove extending into the spud, wherein the retaining ring groove is positioned above the lower ledge;
a retaining ring that is removeably inserted into the retaining ring groove such that the retaining ring extends inward from the inner surface of the spud; and
a cover plate having an upper surface and a lower surface opposite the upper surface, nested within the inner surface of the spud and retained within a vertical gap between the lower ledge of the spud and the retaining ring while the retaining ring is inserted into the retaining ring groove of the spud.

2. The storage container of claim 1, further comprising one or more bags within the interior of the storage container.

3. The storage container of claim 2, wherein the one or more bags include a first bag and a second bag.

4. The storage container of claim 3, wherein the first bag and the second bag are part of a multi-chambered bag and the first bag and the second bag are separated by a seam.

5. The storage container of claim 1, further comprising a diptube coupled to the cover plate and that extends into the interior of the storage container.

6. The storage container of claim 2, wherein the one or more bags are coupled to the cover plate.

7. The storage container of claim 1, wherein the cover plate is configured to contact the retaining ring upon the interior of the storage container reaching or exceeding a threshold pressure.

8. The storage container of claim 7, wherein the threshold pressure is less than 90 pounds per square inch (psi).

9. The storage container of claim 7, wherein the threshold pressure is less than 15 psi.

10. The storage container of claim 7, wherein the threshold pressure is less than 5 psi.

11. The storage container of claim 1, wherein the cover plate includes a rim that extends around a circumference of the cover plate.

12. The storage container of claim 11, wherein the rim is vertically offset lower than the upper surface of the cover plate to create an upper notch.

13. The storage container of claim 12, wherein the upper notch has a depth such that the retaining ring is level with the upper surface of the cover plate when the rim is pressed upward against the retaining ring.

14. The storage container of claim 11, wherein at least one of the rim or the inner surface of the spud includes a seal slot configured to receive a seal.

15. The storage container of claim 1, wherein the retaining ring is a spiral retaining ring having an initial diameter, wherein the retaining ring is configured to be compressible inwards to temporarily cause a reduced diameter of the retaining ring, and return to the initial diameter upon release of the retaining ring.

16. The storage container of claim 1, wherein the retaining ring comprises a tab extending from the retaining ring.

17. The storage container of claim 1, wherein the retaining ring comprises a cutout configured to receive a tool for removal of the retaining ring from the retaining ring groove.

18. A spud configured to be coupled to the body of a storage container, the spud comprising:
an outer surface and an inner surface opposite the outer surface, wherein the inner surface comprises:
a lower ledge extending inwards from the inner surface of the spud, and
a retaining ring groove extending into the spud, wherein the retaining ring groove is positioned above the lower ledge.

19. The spud of claim 18, wherein the inner surface further comprises a seal slot configured to receive a seal.

20. A storage container comprising:
a body that defines an interior of the storage container, wherein the body includes a top end and a bottom end opposite the top end;
a spud coupled to the top end of the body, wherein the spud includes an outer surface and an inner surface, the inner surface comprising:
a lower ledge extending inwards from the inner surface of the spud, and
a retaining ring groove extending into the spud, wherein the retaining ring groove is positioned above the lower ledge;
a retaining ring that is removeably inserted into the retaining ring groove such that the retaining ring extends inward from the inner surface of the spud, wherein the retaining ring has an initial diameter and is configured to be compressible inwards to temporarily cause a reduced diameter of the retaining ring and return to the initial diameter upon release of the retaining ring; and
a cover plate having an upper surface and a lower surface opposite the upper surface, nested within the inner surface of the spud and retained within a vertical gap between the lower ledge of the spud and the retaining ring while the retaining ring is inserted into the retaining ring groove of the spud, wherein the upper surface of the cover plate is configured to contact the retaining ring upon the interior of the storage container reaching or exceeding a threshold pressure.
